(19) United States
(12) Patent Application Publication
(10) Pub. No.: US 2003/0038215 A1
(43) Pub. Date: Feb. 27, 2003

(54) Cruciform parachute assembly

(76) Inventors: Richard J. Benney, Stow, MA (US); Gary Peek, St. Charles, MO (US); Sanjay Patel, Framingham, MA (US); Jean Potvin, St. Jacob, IL (US)

Correspondence Address: U.S. Army Solider, Biological & Chemical Command, Kansas Street, Natick, MA, 01760, US

(21) Appl. No.: 09/942,279

(22) Filed: Aug. 27, 2001

(51) Int. Cl. B64D 17/02

(52) U.S. Cl. 244/145

(57) ABSTRACT

A parachute assembly exhibits a drogue-like configuration upon deployment and thereafter a larger soft landing configuration. The assembly includes a canopy having arms for extending outwardly from a crown portion, a group of suspension lines extending from each outward end of each arm, and a slider having grommets therein, each group of suspension lines extending through one of the grommets. The slider is disposed proximate the arm outward ends upon deployment of the assembly. A series of reefing rings is fixed to the canopy crown portion. A reefing line extends through the reefing rings to retain the canopy crown portion in a gathered condition to effect the drogue-like configuration. A cutter cuts the reefing line to allow expansion of the canopy crown portion, urging the arms to expand, such that the suspension lines urge the slider down the suspension lines, permitting gradual opening of the canopy to the larger soft landing configuration.

### STATEMENT OF GOVERNMENT INTEREST

The invention described herein may be manufactured and used by and for the Government of the United States of America for Governmental purposes without the payment of any royalties thereon.

### BACKGROUND OF THE INVENTION

1. Field of the Invention

The invention relates to parachutes and is directed more particularly to a cruciform parachute having facility for exhibiting a drogue-like configuration upon deployment and, thereafter, for assuming a larger soft landing configuration.

2. Description of the Prior Art

Cargo air drops from high altitudes usually involve the use of dual parachute systems in which a small drogue-type parachute stabilizes the payload during freefall, and a large parachute is intended to effect a soft landing of the payload. Such systems require the use of at least two deployment bags and assorted rigging components. Further, the use of a pyrotechnic cutter for each canopy is required. One illustration of a dual parachute assembly occurs in U.S. Pat. No. 4,955,564, issued Sep. 11, 1990 to James D. Reuter, and an illustration of a pyrotechnic cutter occurs in U.S. Pat. No. 3,895,552, issued Jul. 22, 1975 to Guy J. Lagofun.

In cargo air drops, cruciform parachutes are often the parachute of choice because of their relative simplicity and consequent low cost. In U.S. Pat. No. 4,834,323, there is shown an illustrative cruciform parachute.

It is deemed desirable to have available for high-altitude cargo drops a cruciform parachute assembly having a single canopy which, upon deployment, assumes the configuration of a drogue parachute and, thereafter, transitions into the configuration of a “main”, or larger soft landing parachute. It is further desirable to provide such an assembly having only one pyrotechnic cutter to initiate the drogue to main transition and full opening shock control.

### SUMMARY OF THE INVENTION

An object of the invention is, therefore, to provide a cruciform parachute assembly having a single canopy which, when deployed, assumes a drogue-like configuration and, thereafter, transitions into the configuration of a larger “main” or soft-landing parachute.

A further object of the invention is to provide such a parachute assembly requiring only a single pyrotechnic cutter for effecting the transition from drogue-like to main parachute and for controlling the shock of the main parachute fully opening.

With the above and other objects in view, as will hereinafter appear, a feature of the present invention is the provision of a cruciform parachute assembly adapted to exhibit a drogue-like configuration upon deployment and thereafter a larger soft landing configuration. The assembly includes a canopy comprising four arms adapted for extending outwardly from a crown portion of the canopy, suspension lines extending from each outward end of each of the arms, a slider of substantially square configuration and having a grommet in each corner thereof, each of the suspension lines extending from one of the arms outward ends extending through one of the grommets, the slider being disposed proximate the arm outward ends upon deployment of the assembly. A series of reefing rings are fixed to the canopy, and an endless reefing line extends through the rings to retain the canopy crown portion in a gathered condition to effect the drogue-like configuration. A cutter is operative to cut the reefing line to allow expansion of the canopy crown portion, urging the arms to expand, to cause the suspension lines to urge the slider to slide down the suspension lines, permitting gradual opening of the canopy to the larger soft landing configuration.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

Reference is made to the accompanying drawings in which is shown an illustrative embodiment of the invention, from which its novel features and advantages will be apparent.

In the drawings:

FIG. 1 is a side elevational view of one form of cruciform parachute assembly illustrative of an embodiment of the invention, the parachute canopy being shown in a configuration assumed immediately after deployment;

FIG. 2 is similar to FIG. 1, but illustrative of the canopy in a further and subsequent configuration;

FIG. 3 is similar to FIG. 2, but illustrative of the canopy in a still further and subsequent configuration;

FIG. 4 is similar to FIG. 3, but illustrative of the canopy in a final inflated configuration;

FIG. 5 is a top plan view of the canopy spread in a planar condition; and

FIG. 6 is a top plan view of a slider portion of the parachute assembly.

### DESCRIPTION OF THE PREFERRED EMBODIMENT

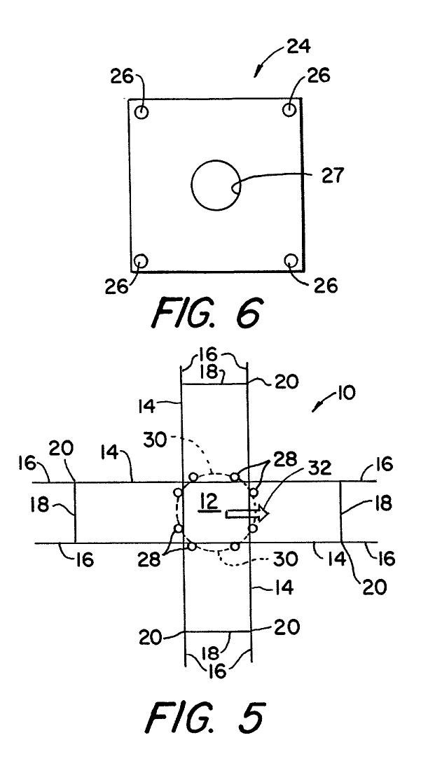

Referring to FIG. 5, it will be seen that an illustrative cruciform canopy 10 includes a crown portion 12 and arms 14 extending outwardly therefrom, typically four arms. Suspension lines 16 extend from each outward end 18 of each of the arms 14.

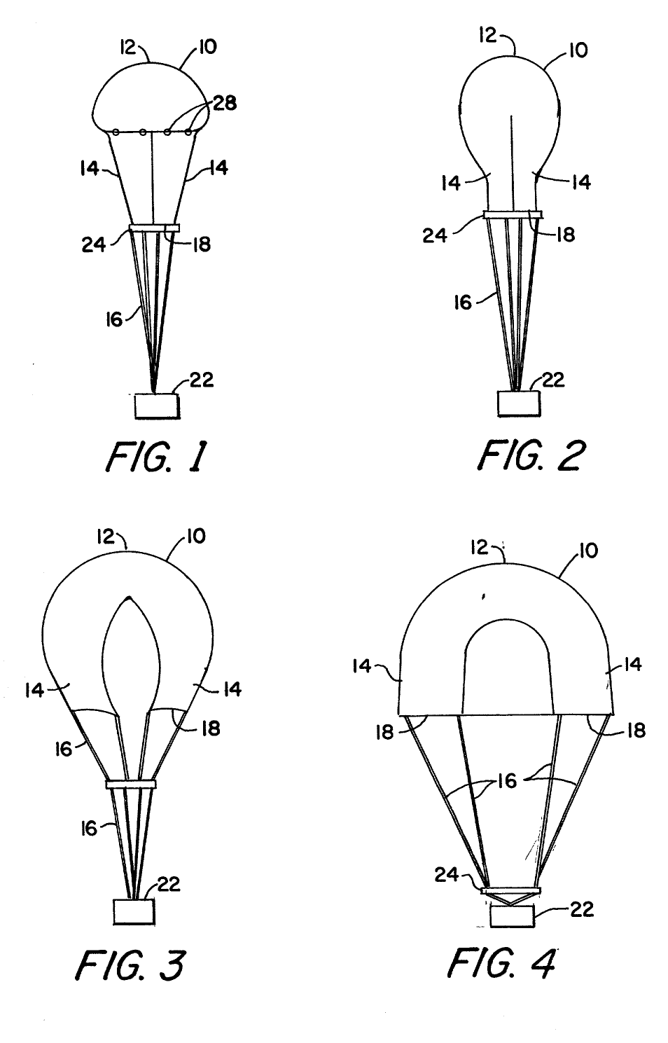

Each of the arms 14 is of a rectangular configuration. Each outward end 18 is accordingly provided with two corners 20, each of the corners 20 having one of the suspension lines 16 fixed thereto. Additional suspension lines (not shown) typically are attached to the arm outward ends 18. While two suspension lines 16 are shown extending from each end of the arms 14, it will be appreciated that a greater number of suspension lines, usually five, or so, extend from each arm end. The suspension lines extending from an arm end constitute a group of suspension lines. The arms 14 are of substantially equal length. The suspension lines are adapted for attachment to a payload 22 (FIGS. 1-4), usually by way of a harness, or the like (not shown).

The assembly further includes a slider 24 (FIGS. 1-4) of a polygonal configuration. A square embodiment is illustrated in FIG. 6, and is provided with a grommet 26 in each corner thereof. Each of the groups of suspension lines 16 extends through one of the grommets 26. Each group of suspension lines 16 extending from an end 18 of an arm 14 extends through one of the grommets 26, such that the slider 24 is slidably mounted on the suspension lines 16. The slider 24 is further provided with a central hole 27 which permits reliable inflation during both drogue-like and canopy spreading phases of deployment of the parachute.

A series of reefing rings 28 (FIGS. 1 and 5) is fixed to the canopy 10 in a circular fashion proximate the canopy crown portion 12. An endless reefing line 30 extends through the reefing rings 28 and serves to bind the crown portion 12 of the canopy, as to permit only limited expansion of the canopy, as illustrated in FIG. 1, to provide a drogue-like configuration.

A cutter 32, shown diagrammatically as an arrow in FIG. 5, and generally of the pyrotechnic type shown in the aforementioned Lagofun patent, is mounted on the assembly for cutting the reefing line 30, to permit further expansion of the canopy crown portion 12 (FIG. 2), which urges the arms 14 to expand.

Expansion of the arms 14 causes the suspension lines 16 to urge the slider 24 downwardly toward the payload 22 (FIG. 3), permitting further opening of the canopy until the slider 24 is proximate the payload 22 and the canopy assumes a larger soft landing configuration (FIG. 4).

The gradual opening of the canopy substantially eliminates shock which typically accompanies the full opening of canopies. The single cutter of the present assembly thus initiates transition of the canopy from drogue-like to soft landing configuration, and also serves to set in motion the slider which dampens the severity of shock customarily caused by canopies snapping into full inflation.

There is thus provided a cruciform parachute assembly having a single canopy which, when deployed, assumes a drogue-like configuration and, thereafter, transitions into the configuration of a larger “main” or soft-landing parachute, and which requires only a single pyrotechnic cutter for effecting the transition from drogue-like to main parachute and for controlling the shock of the main parachute fully opening.

It is to be understood that the present invention is by no means limited to the particular construction herein disclosed and/or shown in the drawings, but also comprises any modification or equivalent within the scope of the claims.

What is claimed is:

1. A cruciform parachute assembly adapted to exhibit a drogue-like configuration upon deployment and thereafter a larger soft landing configuration, the assembly comprising:
a canopy comprising a crown portion and arms extending outwardly therefrom;
suspension lines extending from each outward end of each of said arms;
a slider of polygonal configuration and having a grommet in each corner thereof, each of the suspension lines extending from one of the arm outward ends extending through one of the grommets, said slider being disposed proximate the arm outward ends upon deployment of the assembly;
reefing rings fixed to said canopy proximate said crown portion;
an endless reefing line extending through said reefing rings to retain the canopy central portion in a gathered condition to effect the drogue-like configuration; and
a cutter mounted on the assembly for cutting said reefing line to allow expansion of the canopy crown portion, urging the arms to expand, to cause said suspension lines to urge said slider to slide down the suspension lines, permitting opening of said canopy to the larger soft landing configuration.

2. The assembly in accordance with claim 1 wherein said reefing rings comprise a series of rings disposed in a circular fashion around the crown of the canopy.

3. The assembly in accordance with claim 1 wherein each of said arms is of a rectangular configuration, each outward end having two corners, and each of the corners having one of the suspension lines fixed thereto.

4. The assembly in accordance with claim 3 wherein said arms comprise four arms extending from said crown portion and of equal length.

5. The assembly in accordance with claim 4 wherein said slider is of a rectangular configuration and in each of said grommets is slidably disposed a group of said suspension lines fixed to one of the arm outward ends.

6. The assembly in accordance with claim 5 wherein said slider is of a square configuration.

7. The assembly in accordance with claim 1 wherein said cutter is a pyrotechnically activated cutter.

8. A cruciform parachute assembly adapted to exhibit a drogue-like configuration upon deployment and thereafter a larger soft landing configuration, the assembly comprising:
a canopy comprising four arms adapted for extending outwardly from a crown portion;
a group of suspension lines extending from each outward end of each of said arms;
a slider of substantially square configuration and having a grommet in each corner thereof, each group of suspension lines extending from one of the arms outward ends and extending through one of the grommets, said slider being disposed proximate the arm outward ends upon deployment of the assembly;
a series of reefing rings fixed to said canopy crown portion;
an endless reefing line extending through said reefing rings to retain the canopy crown portion in a gathered condition to effect the drogue-like configuration; and
a cutter operative to cut said reefing line to allow expansion of the canopy crown portion, urging the arms to expand, to cause said suspension lines to urge said slider to slide down the suspension lines permitting gradual opening of said canopy to the larger soft landing configuration.

9. The assembly in accordance with claim 8 wherein said series of reefing rings is disposed in a circular fashion around the crown of the canopy.

10. The assembly in accordance with claim 8 wherein each of said arms is of a rectangular configuration, each outward end having two corners, and each of the corners having one of the suspension lines fixed thereto.
